(19) United States
(12) Patent Application Publication
(10) Pub. No.: US 2026/0173091 A1
(43) Pub. Date: Jun. 18, 2026

(54) SENSING RESOURCE POOL PRECONFIGURATION

(71) Applicant: QUALCOMM Incorporated, San Diego, CA (US)

(72) Inventors: Preeti KUMARI, San Diego, CA (US); Kapil GULATI, Belle Mead, NJ (US); Stelios STEFANATOS, San Diego, CA (US); Shijun WU, San Diego, CA (US); Junyi LI, Greentown, PA (US)

(21) Appl. No.: 19/126,229

(22) PCT Filed: Dec. 19, 2023
(86) PCT No.: PCT/US2023/084788

§ 371 Date: Apr. 30, 2025

(30) Foreign Application Priority Data
Dec. 29, 2022 (GR) 20220101088

(51) Int. Cl. H04W 72/23

(52) U.S. Cl. CPC H04W 72/23

(57) ABSTRACT

Method and apparatus for sensing resource pools for single stage or multi stage sensing using uplink resources. The apparatus receives a sensing resource pool configuration using uplink resources for a joint communication and radar system. The sensing resource pool configuration is based on at least one of a time resource allocation, a space resource allocation, or a frequency resource allocation. The apparatus performs a sensing operation based on the sensing resource pool configuration. The apparatus selects a first sensing resource pool from the plurality of sensing resource pools. The apparatus transmits an ACK or a NACK in response to a selection of the first sensing resource pool.

### CROSS-REFERENCE TO RELATED APPLICATION

This application claims the benefit of Greek patent application No. 20220101088, entitled “SENSING RESOURCE POOL PRECONFIGURATION” and filed on Dec. 29, 2022, which is expressly incorporated by reference herein in its entirety.

### TECHNICAL FIELD

The present disclosure relates generally to communication systems, and more particularly, to a configuration for sensing resource pools for single stage or multi stage sensing using uplink resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a sensing resource pool configuration using uplink resources for a joint communication and radar system, wherein the sensing resource pool configuration is based on at least one of a time resource allocation, a space resource allocation, or a frequency resource allocation. The apparatus performs a sensing operation based on the sensing resource pool configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of a joint communication and radar system.

FIG. 4B is a diagram illustrating an example of a co-design of communication and radar system.

FIG. 5 is a diagram illustrating an example of sensing on uplink resources.

FIG. 6 is a diagram illustrating an example of a single-stage uplink sensing.

FIG. 7 is a diagram illustrating an example of a two-stage uplink sensing.

FIG. 8 is a diagram illustrating an example of a scanning phase and a tracking phase using scan and track resource pools.

FIG. 9 is a call flow diagram of signaling between a UE and a network entity.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

In wireless communication systems, such as joint communication and radar (JCR) systems may be categorized as cooperative JCR systems or co-design of communication and radar systems. In cooperative JCR systems some knowledge is shared between the communication system and radar system in an effort to improve their performance. An advantage of cooperative JCR systems may include spectrum reuse and the ease of implementation. In co-design of communication and radar systems, a common transmitter or receiver may be used for both communication and radar functionalities. An advantage of co-design of communication and radar systems may include hardware and spectrum reuse. Automotive applications may utilize single stage sensing operations which may call for high density of vehicular radars with a high-resolution and a high update rate. However, single stage sensing operations may lead to a large communication overhead. In some instances, automotive applications may utilize two stage sensing operation comprising a scanning phase and a tracking phase. The scanning phase may have a lower resolution to detect the presence of obstacles or vehicles, for example in automotive applications, and the tracking phase may have a higher resolution, than that of the scanning phase, for refined target detection. Any obstacle or vehicle detected during the scanning phase will be tracked during the tracking phase.

Various aspects relate generally to a configuration for sensing resource pools for single stage of two stage sensing using uplink resources. Two stage sensing operations using scanning and tracking phases may enable radar sensing with low overhead, in comparison to single stage sensing operations.

At least one advantage of the disclosure is that two stage sensing may allow for multi-radar sensing over shared uplink communication resources with low overhead. At least one advantage of configuring sensing resource pools for two stage sensing is a reduction of overhead, which may improve performance.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

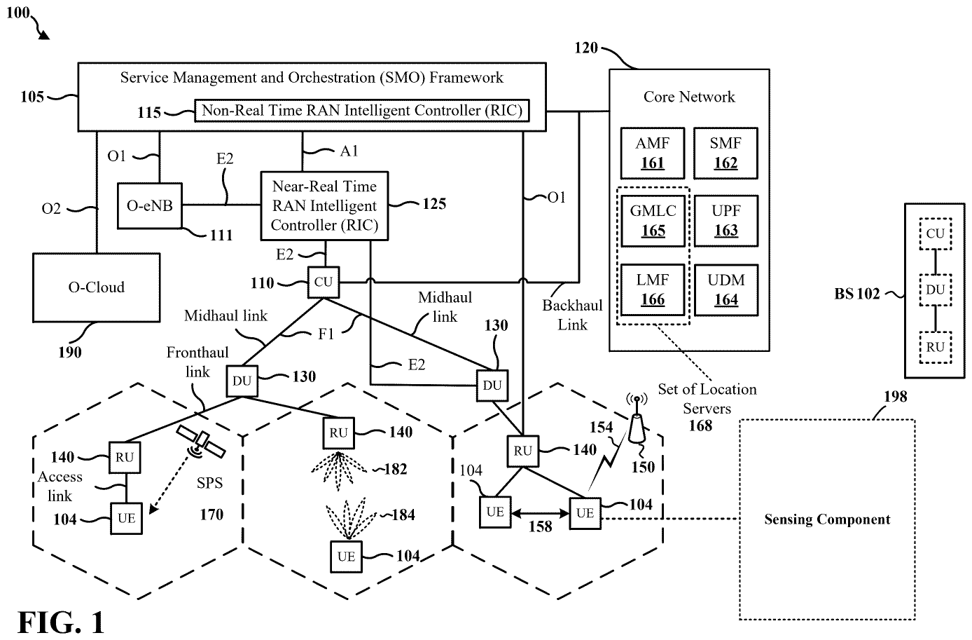

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a sensing component 198 configured to receive a sensing resource pool configuration using uplink resources for a joint communication and radar system, wherein the sensing resource pool configuration is based on at least one of a time resource allocation, a space resource allocation, or a frequency resource allocation; and perform a sensing operation based on the sensing resource pool configuration.

Although the following description may be focused on 5G NR, the concepts described herein may be applicable to other similar areas, such as LTE, LTE-A, CDMA, GSM, and other wireless technologies.

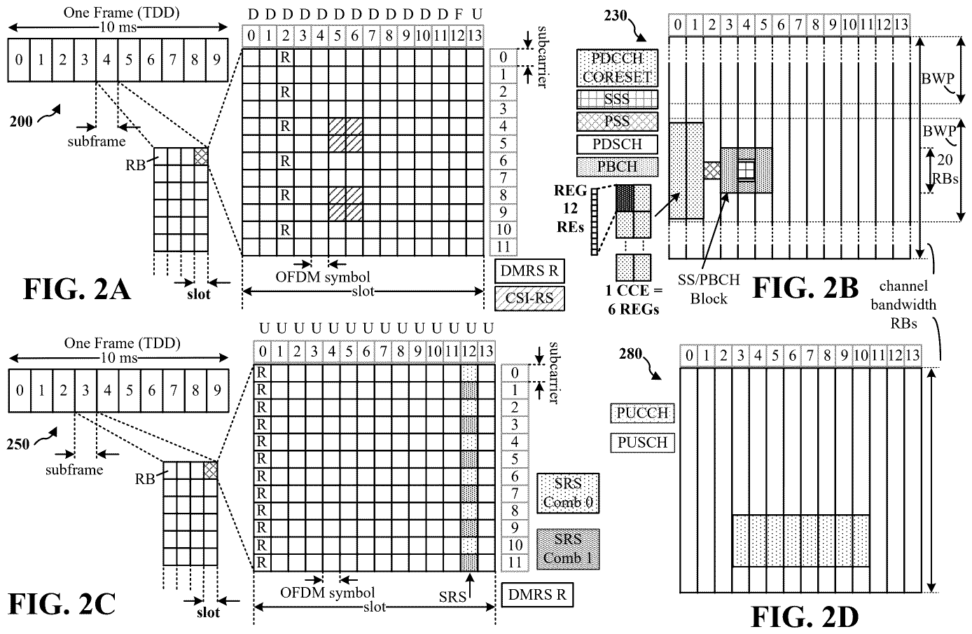

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

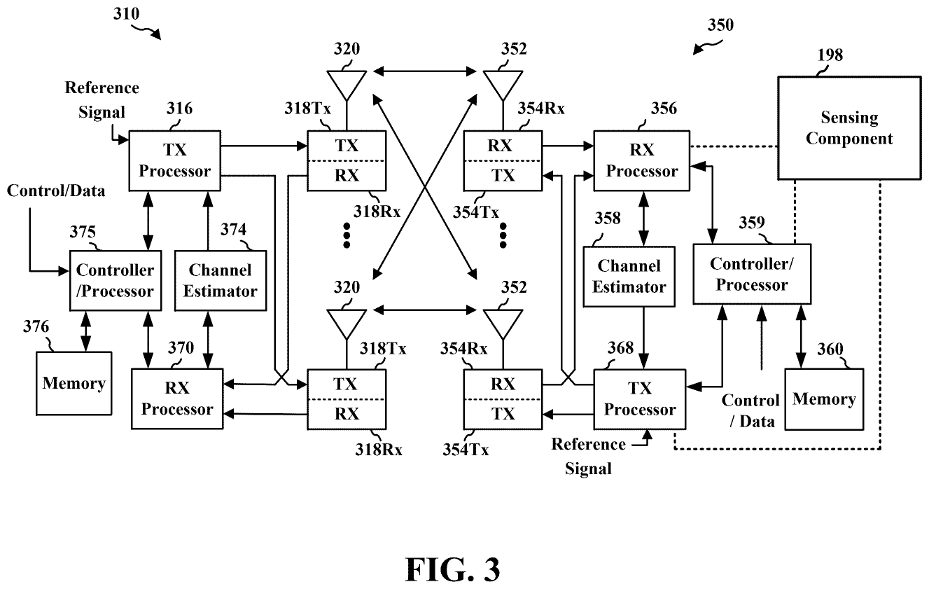

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing component 198 of FIG. 1.

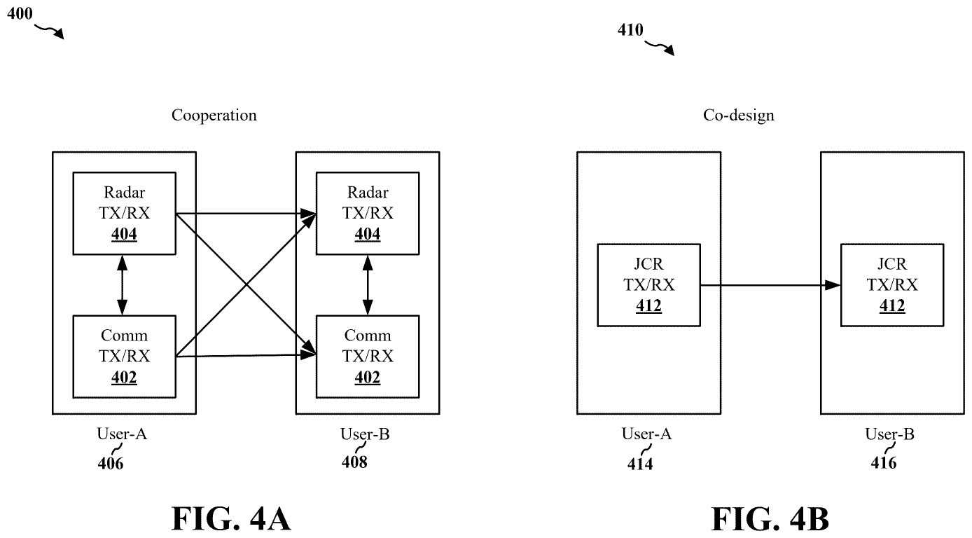

In wireless communication systems, such as joint communication and radar (JCR) systems may be categorized as cooperative JCR systems or co-design of communication and radar systems. FIG. 4A is a diagram 400 of a cooperative JCR system. In cooperative JCR systems some knowledge is shared between the communication system (e.g., comm tx/rx 402) and radar system (e.g., radar tx/rx 404) in an effort to improve their performance, without altering the core operation of radar and communication systems. In some instances, knowledge may be shared between the communication system and radar system between different users. For example, in the diagram 400 of FIG. 4A, knowledge may be shared between the communication systems and radar systems of User-A 406 and User-B 408. An advantage of cooperative JCR systems may include spectrum reuse and the ease of implementation. FIG. 4B is a diagram 410 of a co-design of communication and radar systems. In co-design of communication and radar systems, a common transmitter or receiver (e.g., JCR tx/rx 412) may be used for both communication and radar functionalities. For example, with reference to diagram 410 of FIG. 4B, the common transmitter or receiver (e.g., JCR tx/rx 412) may be used for communication between User-A 414 and User-B 416. Co-design of communication and radar systems may require modification in the transmit waveform generation or the receiver processing of both or either of the communication and radar systems. An advantage of co-design of communication and radar systems may include hardware and spectrum reuse.

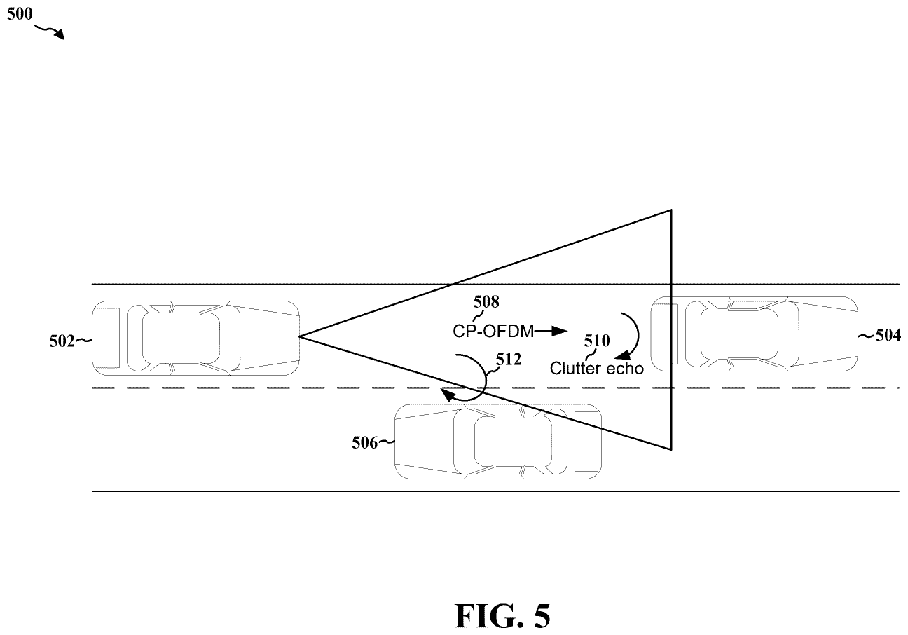

With reference to diagram 500 of FIG. 5, sensing may be performed on uplink resources. For example, vehicle UE 502 may sense surrounding objects (e.g., vehicles 504, 506) for automotive applications, such as but not limited to collision avoidance. In some instances, the vehicle UE 502 may be travelling on a road at a rate of 12 m/s while vehicle 504 may be travelling on the road in the same direction as vehicle UE 502 at a rate of 20 m/s, while vehicle 506 is travelling on the road, in an opposite direction, at a rate of 20 m/s. The vehicle UE 502 may perform a sensing operation via CP-OFDM 508 and may detect clutter echo 510 from vehicle 504 and clutter echo 512 from vehicle 506. To enable the vehicle UE side JCR sensing, the uplink resources may be reused for sensing. Uplink resources may be shared between communication and radar modes. For example, the uplink resources may be separate resources for communication or radar, such as using time division multiplexing mode. In such instances, SRS may be utilized as a sensing waveform, or may be the same resource for communication and radar with a joint co-design waveform.

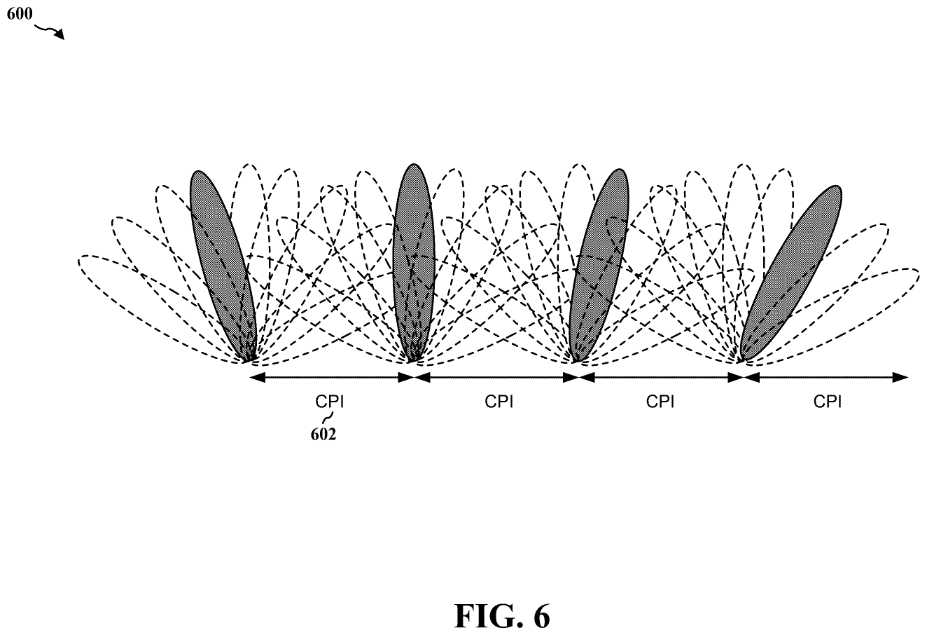

FIG. 6 provides a diagram 600 of a single stage sensing operation. Automotive applications may utilize single stage sensing operations which may call for high density of vehicular radars with a high-resolution and a high update rate. For example, the diagram 600 provides an example of a single phase sensing with certain per-frame requirements. The coherent processing interval (CPI) 602 may correspond to a radar frame. In the diagram 600 of FIG. 6, the CPI per beam may be 5.1 ms, with a bandwidth of 0.5 GHz, and a SCS of 120 kHz, for a Δv=0.4 m/s at f_{c}=73 GHz, ΔR=30 cm. The single stage sensing operation having an update rate of 20 frames per second with a 50 ms sensing period may result in more than 10% of the system resources being utilized per-beam and per-user. As such, single stage sensing operations may lead to a large communication overhead.

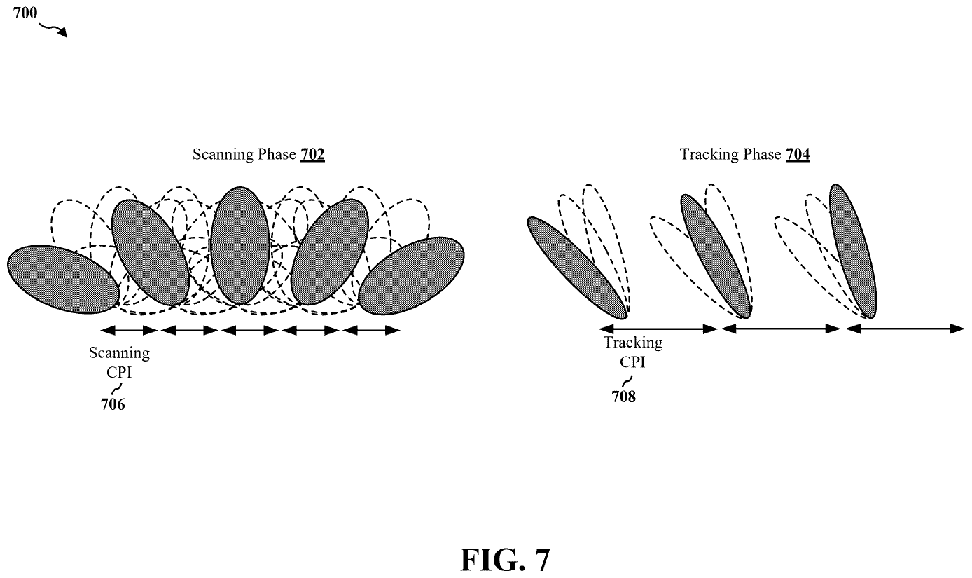

FIG. 7 provides a diagram 700 of a two stage sensing operation. The two stage sensing operation may comprise a scanning phase 702 and a tracking phase 704. The scanning phase 702 may have a lower resolution to detect the presence of obstacles or vehicles, for example in automotive applications. The scanning phase may comprise a scanning CPI 706 where the scanning CPI per beam is 1 ms, with a bandwidth of 150 MHz, and a SCS of 120 kHz, for Δv=2 m/s, ΔR=1m. The tracking phase may have a higher resolution, than that of the scanning phase, for refined target detection. Any obstacle or vehicle detected during the scanning phase will be tracked during the tracking phase. The tracking phase may comprise a tracking CPI 708 where the tracking CPI per beam is 5 ms, with a bandwidth of 0.5 GHz with a comb-5 decimation in time (e.g., 1 in every 5^{th} symbol), and a comb-4 decimation in frequency (e.g., 1 in every 4^{th} RE). The two stage sensing operation having an update rate of 20 frames per second may result in approximately 4.5% of the system resources per user and per detected target, such that approximately 9% of the system resources per user, in an instance where 2 targets are detected within a field of view of the device performing the two stage sensing operation. As such, two stage sensing operations using scanning and tracking phases may enable radar sensing with low overhead, in comparison to single stage sensing operations. Two stage sensing may allow for multi-radar sensing over shared uplink communication resources with low overhead.

Single stage sensing transmission may be triggered on demand to cater to the needs of certain applications with a few target beam directions to sense with low overhead. In two stage sensing, requirements for scanning (in all beam directions, unlike single-stage sensing) and for tracking (selected beam directions based on prior scanning phase) may be different. For example, the scanning phase may be statically or semi-persistently utilized for sensing periodically. Key performance indicators may include large unambiguous velocity estimation, long range radar sensing, or wide field of view which may come at the cost of low resolution. In addition, the tracking phase may be semi-persistently or dynamically triggered after the scanning phase, if targets, obstacles, vehicles, etc., have been detected in the scanning phase.

Aspects presented herein provide a configuration for sensing resource pools for single stage of two stage sensing using uplink resources. At least one advantage of configuring sensing resource pools for two stage sensing is a reduction of overhead, which may improve performance. Sensing resource pool configurations may be based on time-space-frequency resource allocations or expected quality of service characteristics. At least another advantage is that different sensing resource pools may be configured for scanning and for tracking.

In some aspects, a device (e.g., UE) configured to perform sensing may receive a sensing resource pool configuration from another device (e.g., base station), where the resource pool configuration may include one or more of a frequency comb (e.g., comb-2, comb-4, comb-6, etc.), a time comb (e.g., comb-2, comb-4, comb-6, etc.), a time periodicity, a maximum frame, a maximum bandwidth, azimuth and elevation beam restrictions (e.g., maximum effective isotropic radiated power (EIRP) in some elevation directions), or a maximum transmit power.

In some aspects, the resource pool configuration may include an expected quality of service level of the sensing resource pool. The quality of service characteristics may include one or more of a maximum or minimum supported detection range, velocity, or angular directions; a resolution or estimation accuracies in the range-velocity-angle domain; an update rate; a latency (e.g., time interval between resource reservation request and transmission start time); probability of detection or false alarm at the maximum supported range-velocity-angle; or a priority index (e.g., a high priority index may indicate an increased priority over a lower priority index).

In some aspects, the resource pool configuration may be configured to comprise separate pools for scanning and tracking phases. For example, the resource pool configuration for the scanning phase may include resources that cater to scanning resources, such as but not limited to, a small bandwidth for low range resolution, wide beams for low-latency scanning or short-range scanning, narrow beams for long-range scanning, a total time duration for low velocity resolution, a comb size in time for large maximum unambiguous velocity estimation, or a comb size in range for large maximum unambiguous range estimation.

The resource pool configuration for the tracking phase may include resources that cater to tracking resources, such as but not limited to, large bandwidth for high range resolution, narrow beams for targeted tracking of targets detected during the scanning phase, total time duration for high velocity resolution, a comb size in time for efficient resource utilization (e.g., velocity may be estimated in combination with the scanning phase), a comb size in range for efficient resource utilization (e.g., range may be estimated in combination with the scanning phase). The configuration of the comb size for the tracking phase may be large or larger than the configuration of the comb size for the scanning phase. The configuration of the total time duration for the tracking phase may be large or larger than the configuration of the total time duration for the scanning phase.

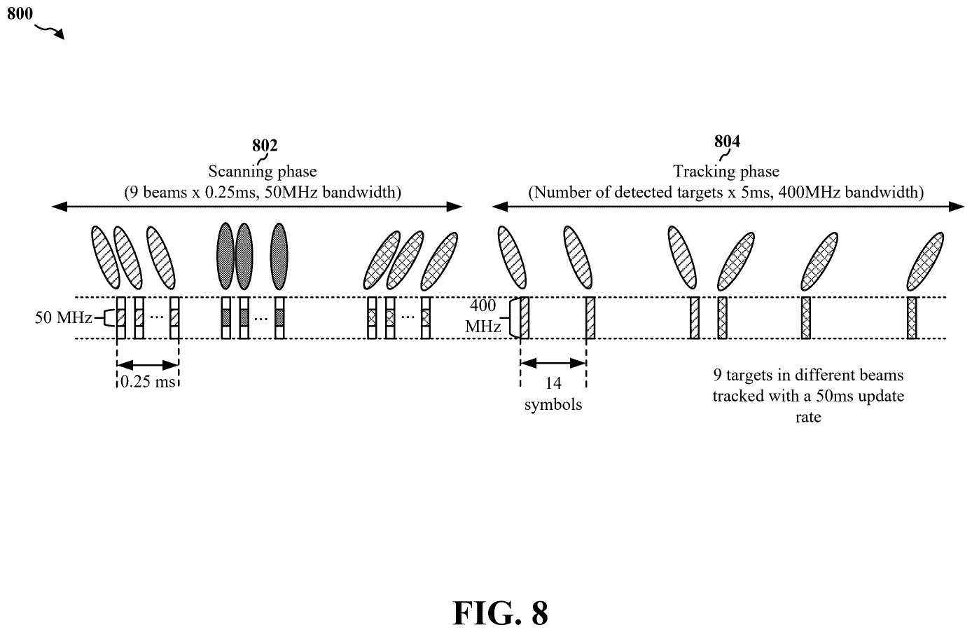

The resource pool configuration comprising separate pools for scanning and tracking phases, an association between the pools or the resources within the pool may be included within the resource pool configuration. The device (e.g., base station) providing the resource pool configuration may provide the association between the separate pools to the UE or device performing the scanning and tracking phases. The association may assist in properly estimating the range, velocity, and angle with high resolution and maximum unambiguous range, velocity, field of view. For example, the scanning phase resource pool may have a comb-4 in the time domain and 0.25 ms per beam (max velocity of 75 m/s and velocity resolution of 21 m/s) associated with a tracking phase resource pool with a comb-14 in the time domain (symbol per slot) and 5 ms per beam (maximum velocity of 21 m/s and velocity resolution of 1 m/s). Together, the association of the scanning phase and the tracking phase may lead to a maximum velocity of 75 m/x and velocity resolution of 21 m/s. For example, diagram 800 of FIG. 8 provides an example of a scanning phase 802 and a tracking phase 804. The scanning phase 802 may comprise 9 receive beams, a comb-4 in the time and frequency domain, and may be configured to scan 0.25 ms per beam with 4 symbol spacing. The maximum absolute velocity may comprise 75.1 m/s with a velocity resolution of 21 m/s. The tracking phase 804 may be configured to track at a rate of 5 ms per target/beam with a 14 symbol spacing, with a comb-4 in the frequency domain. The maximum absolute velocity may comprise 21 m/s with a velocity resolution of 1 m/s.

In some aspects, the resource pool configuration may comprise a plurality of resource pools. In such instances, the device (e.g., UE) may select a resource pool from the plurality of resource pools. In some aspects, the device may select an appropriate resource pool to transmit in based on the matching resource or quality of service requirements. In some aspects, the device may select a resource pool that may not match or be compatible with the resource or quality of service requirement, when either the resources are insufficient or more than the required one. For example, a narrow band sensing transmission may be performed exceptionally over the large bandwidth instead of a small bandwidth resource pool. The device may choose a different pool if it measures CBR-type quantities indicating that its nominal pool is very congested whereas one or more other pools are not. In some instances, there may be a limit of how often a different than the nominal pool can be used (e.g., timer based, a duty cycle quantity, etc.). In some instances, if a different pool is to be used, the device may attempt to protect “legitimate” UEs by transmitting with lower power. In some instances, the device may explicitly request permission from the device (e.g., base station) that provided the resource pool configuration for a temporary change of pools with the device expected resource utilization in the future. In some instances, the device (e.g., base station) that provided the resource pool configuration may freely allow the request or may block the request in a semi-static manner. In some instances, the device (e.g., UE) may transmit an ACK or a NACK if the device is able to get the desired resource.

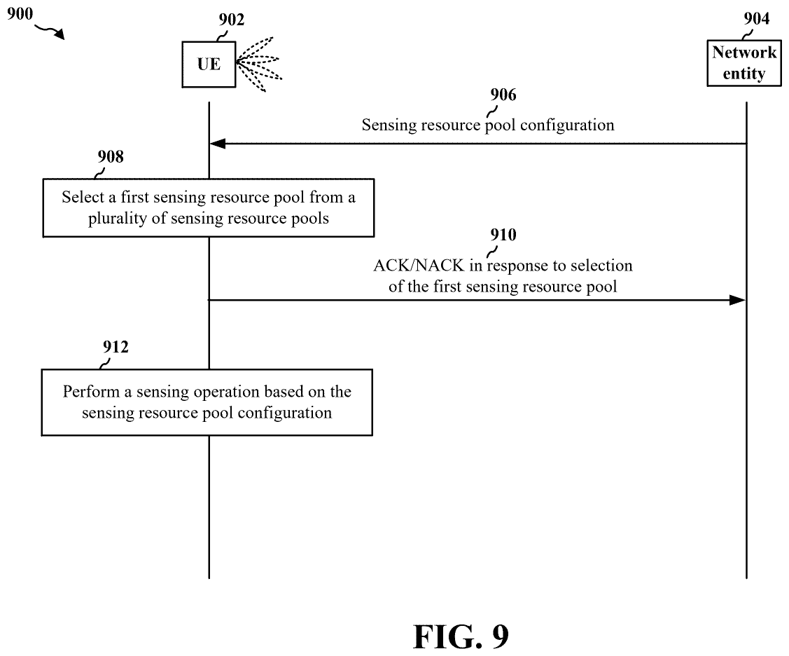

FIG. 9 is a call flow diagram 900 of signaling between a UE 902 and a network entity 904. The network entity 904 may comprise a base station configured to provide at least one cell. The UE 902 may be configured to communicate with the network entity 904. For example, in the context of FIG. 1, the network entity 904 may correspond to base station 102 and UE 902 may correspond to at least UE 104. In another example, in the context of FIG. 3, the network entity 904 may correspond to base station 310 and the UE 902 may correspond to UE 350.

At 906, the network entity may output a sensing resource pool configuration to the UE 902. The UE 902 may receive the sensing resource pool configuration from the network entity 904. The UE may receive the sensing resource pool configuration using uplink resources for a joint communication and radar system. The sensing resource pool configuration may be based on at least one of a time resource allocation, a space resource allocation, or a frequency resource allocation. In some aspects, the sensing resource pool configuration may comprise a frequency comb or a time comb. In some aspects, the sensing resource pool configuration may comprise a time periodicity. In some aspects, the sensing resource pool configuration may comprise a maximum frame or a maximum bandwidth of the sensing operation. In some aspects, the sensing resource pool configuration may comprise azimuth parameters or elevation parameters for beams of the sensing operation. In some aspects, the sensing resource pool configuration may be based on an expected quality of service level of a sensing resource pool. The expected quality of service may be based on at least one of a supported detection range, a supported velocity, or supported angular directions. The expected quality of service may be based on at least one of an update rate or a latency to perform the sensing operation. The expected quality of service may be based on at least one of a detection rate or a priority index.

At 908, the UE 902 may select a first sensing resource pool from the plurality of sensing resource pools. The UE 902 may select the first sensing resource pool from the plurality of sensing resources pools in instances where the sensing resource pool configuration comprises a plurality of sensing resource pools. In some aspects, the first sensing resource pool may be selected based on matching resources or an expected quality of service. In some aspects, the first sensing resource pool selected may be inconsistent with matching resources or an expected quality of service if resources within the first sensing resource pool are insufficient or excessive.

At 910, the UE 902 may transmit an ACK or a NACK in response to a selection of the first sensing resource pool. The UE 902 may transmit the ACK or the NACK to the network entity 904. The network entity 904 may obtain the ACK or the NACK from the UE 902. The UE 902 may transmit the ACK or the NACK in response to the selection of the first sensing resource pool in instances where the sensing resource pool configuration comprises a plurality of sensing resource pools.

At 912, the UE 902 may perform a sensing operation. The UE 902 may perform the sensing operation based on the sensing resource pool configuration. For example, the UE 902 may perform the sensing operation to detect obstacles or surrounding objects for automotive applications, such as but not limited to collision avoidance. In some aspects, the sensing operation may comprise a scan phase, wherein the sensing resource pool configuration comprises a scan resource pool configuration. The scan resource pool configuration comprises at least one of a low resolution bandwidth for a low range resolution, a scan beam configuration comprising one or more wide beams for a low-latency scan, a short-range scan, or a long-range scan, a first time duration for a low velocity resolution, or a scan comb size for a velocity estimation or a range estimation. In some aspects, the sensing operation may comprise a track phase, wherein the sensing resource pool configuration comprises a track resource pool configuration. The track resource pool configuration comprises at least one of a high resolution bandwidth for a high range resolution, a track beam configuration comprising one or more narrow beams for a targeted tracking, a second time duration for a high velocity resolution, or a track comb size for a velocity estimation or a range estimation in connection with the scan phase.

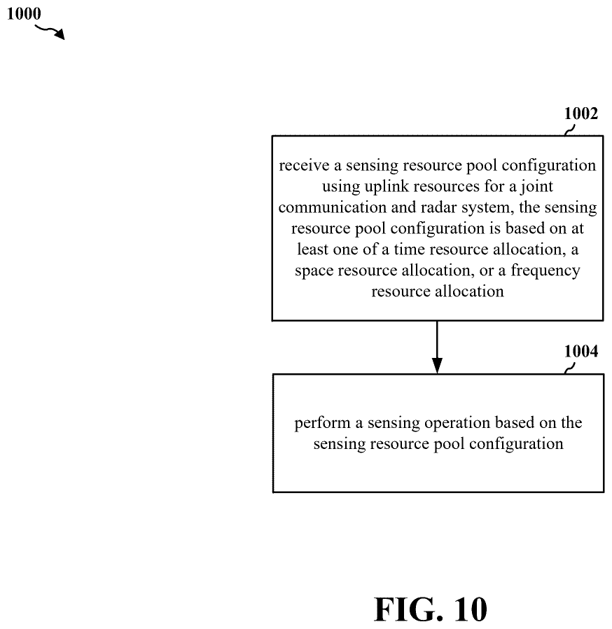

FIG. 10 is a flowchart 1000 of a method of wireless communication. The method may be performed by a UE (e.g., the UE 104; the apparatus 1204). One or more of the illustrated operations may be omitted, transposed, or contemporaneous. The method may configure sensing resource pools for single stage or multi-stage sensing using uplink resources.

At 1002, the UE may receive a sensing resource pool configuration. For example, 1002 may be performed by sensing component 198 of apparatus 1204. The UE may receive the sensing resource pool configuration using uplink resources for a joint communication and radar system. The sensing resource pool configuration may be based on at least one of a time resource allocation, a space resource allocation, or a frequency resource allocation. In some aspects, the sensing resource pool configuration may comprise a frequency comb or a time comb. In some aspects, the sensing resource pool configuration may comprise a time periodicity. In some aspects, the sensing resource pool configuration may comprise a maximum frame or a maximum bandwidth of the sensing operation. In some aspects, the sensing resource pool configuration may comprise azimuth parameters or elevation parameters for beams of the sensing operation. In some aspects, the sensing resource pool configuration may be based on an expected quality of service level of a sensing resource pool. The expected quality of service may be based on at least one of a supported detection range, a supported velocity, or supported angular directions. The expected quality of service may be based on at least one of an update rate or a latency to perform the sensing operation. The expected quality of service may be based on at least one of a detection rate or a priority index.

At 1004, the UE may perform a sensing operation. For example, 1004 may be performed by sensing component 198 of apparatus 1204. The UE may perform the sensing operation based on the sensing resource pool configuration. In some aspects, the sensing operation may comprise a scan phase, wherein the sensing resource pool configuration comprises a scan resource pool configuration. The scan resource pool configuration comprises at least one of a low resolution bandwidth for a low range resolution, a scan beam configuration comprising one or more wide beams for a low-latency scan, a short-range scan, or a long-range scan, a first time duration for a low velocity resolution, or a scan comb size for a velocity estimation or a range estimation. In some aspects, the sensing operation may comprise a track phase, wherein the sensing resource pool configuration comprises a track resource pool configuration. The track resource pool configuration comprises at least one of a high resolution bandwidth for a high range resolution, a track beam configuration comprising one or more narrow beams for a targeted tracking, a second time duration for a high velocity resolution, or a track comb size for a velocity estimation or a range estimation in connection with the scan phase.

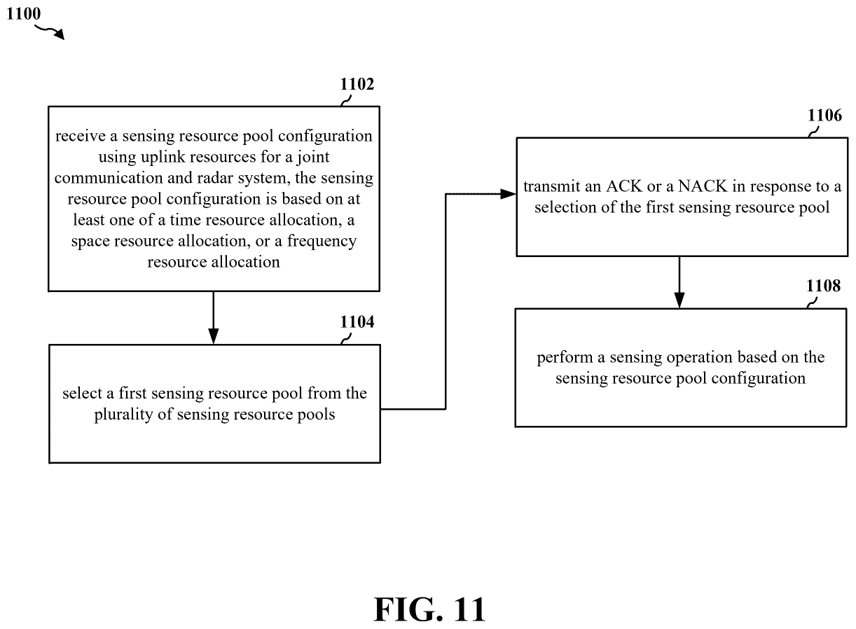

FIG. 11 is a flowchart 1100 of a method of wireless communication. The method may be performed by a UE (e.g., the UE 104; the apparatus 1204). One or more of the illustrated operations may be omitted, transposed, or contemporaneous. The method may configure sensing resource pools for single stage or multi-stage sensing using uplink resources.

At 1102, the UE may receive a sensing resource pool configuration. For example, 1102 may be performed by sensing component 198 of apparatus 1204. The UE may receive the sensing resource pool configuration using uplink resources for a joint communication and radar system. The sensing resource pool configuration may be based on at least one of a time resource allocation, a space resource allocation, or a frequency resource allocation. In some aspects, the sensing resource pool configuration may comprise a frequency comb or a time comb. In some aspects, the sensing resource pool configuration may comprise a time periodicity. In some aspects, the sensing resource pool configuration may comprise a maximum frame or a maximum bandwidth of the sensing operation. In some aspects, the sensing resource pool configuration may comprise azimuth parameters or elevation parameters for beams of the sensing operation. In some aspects, the sensing resource pool configuration may be based on an expected quality of service level of a sensing resource pool. The expected quality of service may be based on at least one of a supported detection range, a supported velocity, or supported angular directions. The expected quality of service may be based on at least one of an update rate or a latency to perform the sensing operation. The expected quality of service may be based on at least one of a detection rate or a priority index.

At 1104, the UE may select a first sensing resource pool from the plurality of sensing resource pools. For example, 1104 may be performed by sensing component 198 of apparatus 1204. The UE may select the first sensing resource pool from the plurality of sensing resources pools in instances where the sensing resource pool configuration comprises a plurality of sensing resource pools. In some aspects, the first sensing resource pool may be selected based on matching resources or an expected quality of service. In some aspects, the first sensing resource pool selected may be inconsistent with matching resources or an expected quality of service if resources within the first sensing resource pool are insufficient or excessive.

At 1106, the UE may transmit an ACK or a NACK in response to a selection of the first sensing resource pool. For example, 1106 may be performed by sensing component 198 of apparatus 1204. The UE may transmit the ACK or the NACK in response to the selection of the first sensing resource pool in instances where the sensing resource pool configuration comprises a plurality of sensing resource pools.

At 1108, the UE may perform a sensing operation. For example, 1108 may be performed by sensing component 198 of apparatus 1204. The UE may perform the sensing operation based on the sensing resource pool configuration. In some aspects, the sensing operation may comprise a scan phase, wherein the sensing resource pool configuration comprises a scan resource pool configuration. The scan resource pool configuration comprises at least one of a low resolution bandwidth for a low range resolution, a scan beam configuration comprising one or more wide beams for a low-latency scan, a short-range scan, or a long-range scan, a first time duration for a low velocity resolution, or a scan comb size for a velocity estimation or a range estimation. In some aspects, the sensing operation may comprise a track phase, wherein the sensing resource pool configuration comprises a track resource pool configuration. The track resource pool configuration comprises at least one of a high resolution bandwidth for a high range resolution, a track beam configuration comprising one or more narrow beams for a targeted tracking, a second time duration for a high velocity resolution, or a track comb size for a velocity estimation or a range estimation in connection with the scan phase.

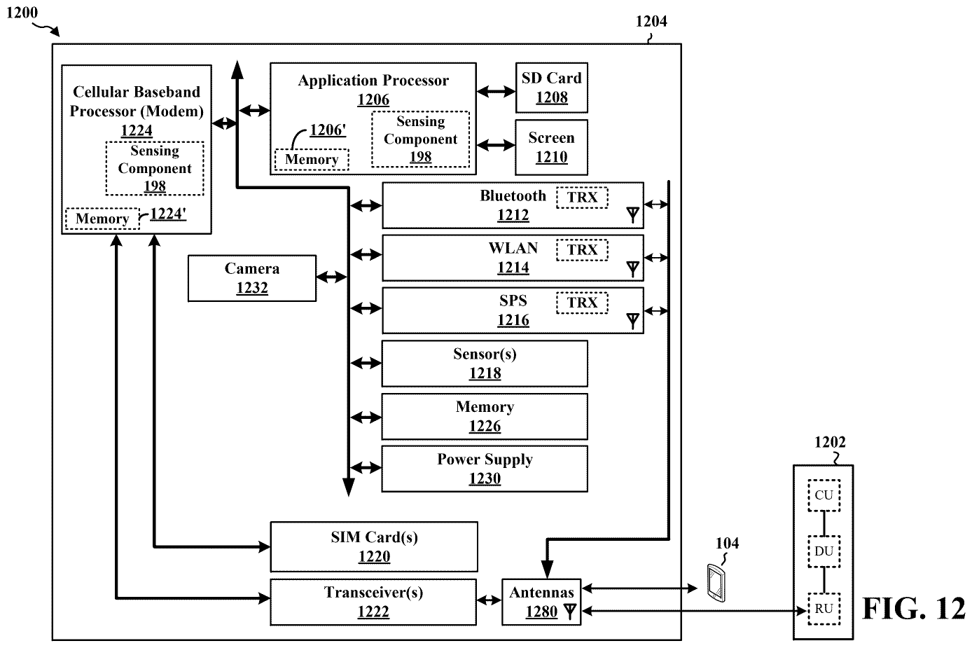

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the component 198 is configured to receive a sensing resource pool configuration using uplink resources for a joint communication and radar system, wherein the sensing resource pool configuration is based on at least one of a time resource allocation, a space resource allocation, or a frequency resource allocation; and perform a sensing operation based on the sensing resource pool configuration. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving a sensing resource pool configuration using uplink resources for a joint communication and radar system. The sensing resource pool configuration is based on at least one of a time resource allocation, a space resource allocation, or a frequency resource allocation. The apparatus includes means for performing a sensing operation based on the sensing resource pool configuration. The apparatus further includes means for selecting a first sensing resource pool from the plurality of sensing resource pools. The apparatus further includes means for transmitting an ACK or a NACK in response to a selection of the first sensing resource pool. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

Various aspects relate generally to a configuration for sensing resource pools for single stage of two stage sensing using uplink resources. Two stage sensing operations using scanning and tracking phases may enable radar sensing with low overhead, in comparison to single stage sensing operations. At least one advantage of the disclosure is that a UE may receive a sensing resource pool configuration using uplink resources for a joint communication and radar system, where the UE may perform a sensing operation based on the sensing resource pool configuration. Performing the sensing operation based on the sensing resource pool configuration may allow the UE to perform a two stage sensing which has a reduced overhead, and may improve performance.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising receiving a sensing resource pool configuration using uplink resources for a joint communication and radar system, wherein the sensing resource pool configuration is based on at least one of a time resource allocation, a space resource allocation, or a frequency resource allocation; and performing a sensing operation based on the sensing resource pool configuration.

Aspect 2 is the method of aspect 1, further includes that the sensing resource pool configuration comprises a frequency comb or a time comb.

Aspect 3 is the method of any of aspects 1 and 2, further includes the sensing resource pool configuration comprises a time periodicity.

Aspect 4 is the method of any of aspects 1-3, further includes that the sensing resource pool configuration comprises a maximum frame or a maximum bandwidth of the sensing operation.

Aspect 5 is the method of any of aspects 1-4, further includes that the sensing resource pool configuration comprises azimuth parameters or elevation parameters for beams of the sensing operation.

Aspect 6 is the method of any of aspects 1-5, further includes that the sensing resource pool configuration is based on an expected quality of service level of a sensing resource pool.

Aspect 7 is the method of any of aspects 1-6, further includes that the expected quality of service is based on at least one of a supported detection range, a supported velocity, or supported angular directions.

Aspect 8 is the method of any of aspects 1-7, further includes that the expected quality of service is based on at least one of an update rate or a latency to perform the sensing operation.

Aspect 9 is the method of any of aspects 1-8, further includes that the expected quality of service is based on at least one of a detection rate or a priority index.

Aspect 10 is the method of any of aspects 1-9, further includes that the sensing operation comprises a scan phase, wherein the sensing resource pool configuration comprises a scan resource pool configuration.

Aspect 11 is the method of any of aspects 1-10, further includes that the scan resource pool configuration comprises at least one of a low resolution bandwidth for a low range resolution, a scan beam configuration comprising one or more wide beams for a low-latency scan, a short-range scan, or a long-range scan, a first time duration for a low velocity resolution, or a scan comb size for a velocity estimation or a range estimation.

Aspect 12 is the method of any of aspects 1-11, further includes that the sensing operation comprises a track phase, wherein the sensing resource pool configuration comprises a track resource pool configuration.

Aspect 13 is the method of any of aspects 1-12, further includes that the track resource pool configuration comprises at least one of a high resolution bandwidth for a high range resolution, a track beam configuration comprising one or more narrow beams for a targeted tracking, a second time duration for a high velocity resolution, or a track comb size for a velocity estimation or a range estimation in connection with the scan phase.

Aspect 14 is the method of any of aspects 1-13, further includes that the sensing resource pool configuration comprises a plurality of sensing resource pools further including selecting a first sensing resource pool from the plurality of sensing resource pools; and transmitting an ACK or a NACK in response to a selection of the first sensing resource pool.

Aspect 15 is the method of any of aspects 1-14, further includes that the first sensing resource pool is selected based on matching resources or an expected quality of service.

Aspect 16 is the method of any of aspects 1-15, further includes that the first sensing resource pool selected is inconsistent with matching resources or an expected quality of service if resources within the first sensing resource pool are insufficient or excessive.

Aspect 17 is an apparatus for wireless communication at a UE including at least one processor coupled to a memory and at least one transceiver, the at least one processor configured to implement any of Aspects 1-16.

Aspect 18 is an apparatus for wireless communication at a UE including means for implementing any of Aspects 1-16.

Aspect 19 is a computer-readable medium storing computer executable code, where the code when executed by a processor causes the processor to implement any of Aspects 1-16.

1. An apparatus for wireless communication at a user equipment (UE), comprising: a memory; and
at least one processor coupled to the memory and, based at least in part on information stored in the memory, the at least one processor is configured to:
receive a sensing resource pool configuration using uplink resources for a joint communication and radar system, wherein the sensing resource pool configuration is based on at least one of a time resource allocation, a space resource allocation, or a frequency resource allocation; and
perform a sensing operation based on the sensing resource pool configuration.

2. The apparatus of claim 1, further comprising a transceiver coupled to the at least one processor.

3. The apparatus of claim 1, wherein the sensing resource pool configuration comprises a frequency comb or a time comb.

4. The apparatus of claim 1, wherein the sensing resource pool configuration comprises a time periodicity.

5. The apparatus of claim 1, wherein the sensing resource pool configuration comprises a maximum frame or a maximum bandwidth of the sensing operation.

6. The apparatus of claim 1, wherein the sensing resource pool configuration comprises azimuth parameters or elevation parameters for beams of the sensing operation.

7. The apparatus of claim 1, wherein the sensing resource pool configuration is based on an expected quality of service level of a sensing resource pool.

8. The apparatus of claim 7, wherein the expected quality of service is based on at least one of a supported detection range, a supported velocity, or supported angular directions.

9. The apparatus of claim 7, wherein the expected quality of service is based on at least one of an update rate or a latency to perform the sensing operation.

10. The apparatus of claim 7, wherein the expected quality of service is based on at least one of a detection rate or a priority index.

11. The apparatus of claim 1, wherein the sensing operation comprises a scan phase, wherein the sensing resource pool configuration comprises a scan resource pool configuration.

12. The apparatus of claim 11, wherein the scan resource pool configuration comprises at least one of:
a low resolution bandwidth for a low range resolution,
a scan beam configuration comprising one or more wide beams for a low-latency scan, a short-range scan, or a long-range scan,
a first time duration for a low velocity resolution, or
a scan comb size for a velocity estimation or a range estimation.

13. The apparatus of claim 11, wherein the sensing operation comprises a track phase, wherein the sensing resource pool configuration comprises a track resource pool configuration.

14. The apparatus of claim 13, wherein the track resource pool configuration comprises at least one of:
a high resolution bandwidth for a high range resolution,
a track beam configuration comprising one or more narrow beams for a targeted tracking,
a second time duration for a high velocity resolution, or
a track comb size for a velocity estimation or a range estimation in connection with the scan phase.

15. The apparatus of claim 1, wherein the sensing resource pool configuration comprises a plurality of sensing resource pools, wherein the at least one processor is configured to:
select a first sensing resource pool from the plurality of sensing resource pools; and
transmit an acknowledgment (ACK) or a negative-ACK (NACK) in response to a selection of the first sensing resource pool.

16. The apparatus of claim 15, wherein the first sensing resource pool is selected based on matching resources or an expected quality of service.

17. The apparatus of claim 15, wherein the first sensing resource pool selected is inconsistent with matching resources or an expected quality of service if resources within the first sensing resource pool are insufficient or excessive.

18. A method of wireless communication at a user equipment (UE), comprising:
receiving a sensing resource pool configuration using uplink resources for a joint communication and radar system, wherein the sensing resource pool configuration is based on at least one of a time resource allocation, a space resource allocation, or a frequency resource allocation; and
performing a sensing operation based on the sensing resource pool configuration.

19-28. (canceled)

29. An apparatus for wireless communication at a user equipment (UE), comprising: means for receiving a sensing resource pool configuration using uplink resources for a joint communication and radar system, wherein the sensing resource pool configuration is based on at least one of a time resource allocation, a space resource allocation, or a frequency resource allocation; and
means for performing a sensing operation based on the sensing resource pool configuration.

30. (canceled)
